(19) United States
(12) Patent Application Publication
(10) Pub. No.: US 2025/0069802 A1
(43) Pub. Date: Feb. 27, 2025

(54) Inductor Arrangement for Generating or Receiving an Electromagnetic Field

(71) Applicant: Huawei Digital Power Technologies Co., Ltd., Shenzhen (CN)

(72) Inventors: Fralett Suarez Sandoval, Munich (DE); Sarai Malinal Torres Delgado, Munich (DE)

(21) Appl. No.: 18/944,814

(22) Filed: Nov. 12, 2024

Related U.S. Application Data
(63) Continuation of application No. PCT/EP2022/062957, filed on May 12, 2022.

(51) Int. Cl. H01F 38/14; H01F 27/28; H01F 27/29; H01F 41/04

(52) U.S. Cl. CPC H01F 38/14; H01F 27/2804; H01F 27/292; H01F 41/042; H01F 2027/2809

(57) ABSTRACT

An inductor arrangement for generating or receiving an electromagnetic field, the inductor arrangement comprising: a flat coil-shaped multi-layer substrate comprising a first conductive layer and a second conductive layer which are separated by an insulating layer, the flat coil-shaped multi-layer substrate being structured to form a planar inductor; and a third conductive layer and a fourth conductive layer deposited on the insulating layer at edges of the structured flat coil-shaped multi-layer substrate, wherein the first conductive layer, the second conductive layer, the third conductive layer and the fourth conductive layer are structured to form a tubular conductive layer, the tubular conductive layer enclosing the flat coil-shaped multi-layer substrate.

### CROSS-REFERENCE TO RELATED APPLICATIONS

This is a continuation of International Patent Application No. PCT/EP2022/062957 filed on May 12, 2022, the disclosure of which is hereby incorporated by reference in its entirety.

### TECHNICAL FIELD

The disclosure relates to the field of wireless power transfer. In particular, the disclosure relates to an inductor arrangement and corresponding method for generating or receiving an electromagnetic field. The disclosure particularly relates to high quality factor planar inductors and substantially planar printed-circuit board inductors used as the inductive component of transmitter or receiver resonators of wireless power transfer systems and fabrication methods of such inductors.

### BACKGROUND

In wireless power transfer systems, the overall system efficiency is a function of the resonators' quality factor and the coupling factor between their inductive elements. The mayor engineering challenge surrounding the existing wireless power transfer systems to recharge battery-powered devices is the reduced positioning freedom of the target device(s) which results in high sensitivity to lateral or angular misalignments between the transmitter and receiver devices such that in some locations the receiver device may not be properly charged or even not charged at all.

In some situations, a drop in the efficiency of the wireless power link due to a reduced coupling coefficient that arose because the wireless power transfer system is meant to provide positioning freedom of the receiver, can be compensated up to a certain point if the transmitter and receiver resonators have a high quality factor. Inductors that have a high quality factor are usually manufactured with thick solid or hollow conductors that occupy large volumes. Having a thick conductor structure is sometimes undesirable in applications with height constraints like a receiver inductor embedded inside a substantially flat receiver device like a mobile phone or a wearable electronic device.

### SUMMARY

This disclosure provides a technique for producing transmitter and receiver resonator arrangements for wireless power transmission that have a high quality factor without substantially increasing the overall thickness of the inductors involved.

The foregoing and other objects are achieved by the features of the independent claims. Further implementation forms are apparent from the dependent claims, the description and the figures.

In particular, the disclosure presents a manufacturing method of substantially planar printed-circuit board inductors used in transmitter or receiver resonator circuits in wireless power transfer systems.

A basic concept is to have a substantially planar inductor comprising a printed-circuit board substrate and conductive materials at the bottom and top sides; a milled-through space between the turns of the inductor and a side-plating that electrically connects the top and bottom sides forming a pipe-like structure of conductive material filled with substrate material.

The disclosed inductors and manufacturing method increase the quality factor of the inductors over existing inductor arrangements.

In particular, the overall system efficiency of the wireless power transfer link is increased since the disclosed inductors and manufacturing methods effectively render inductors with a higher quality factor due to the added conductive material added by the electrodeposition that connects the conducting traces found on the top and the bottom of the disclosed inductor. Additionally, depending on the frequency of operation, having an inductor whose core is made of a non-conductive material diminishes the losses associated with the skin effect.

In order to describe the disclosure in detail, the following terms and notations will be used.
WPT: wireless power transmission
PCB: printed circuit board
DC: direct current

In this disclosure, wireless power transfer, transmitter devices for wirelessly powering receiver devices and wireless powering systems are described.

Wireless power transfer is the transmission of electrical energy without the use of wires as a physical link. This technology uses a transmitter device capable of generating a time-varying electromagnetic field that causes a circulating electric field through a receiver device (or devices) based on the principle of electromagnetic induction. The receiver device (or devices) is (are) capable of being supplied directly from this circulating electric field or they convert it to a suitable power level to supply to an electrical load or battery connected to them.

In the following, inductor arrangements for generating or receiving an electromagnetic field are described. The inductor arrangements may comprise one or more inductors or coils, respectively. In the following description, the term “inductor” refers to a component in an electric or electronic circuit that possesses inductance and that is shaped according to a specific geometry, e.g., in the form of a coil or spiral or a meander.

Nowadays the number of battery-powered electronic devices is increasing rapidly because they provide freedom of movement and portability. These devices should be continuously recharged to ensure they function. Their charging frequency could be diminished by the use of a large battery, but these impact the overall cost of the electronic device, as well as their weight and size.

Charging of battery-powered electronic devices is usually done with the use of a wall charger and a dedicated cable that connects to an input port of the device to be charged to establish an electrical connection between the power supply and the power-hungry device. Some disadvantages of this charging mechanism are summarized as: a) The connector at this input port is susceptible to mechanical failure due to the connection/disconnection cycles required to charge the battery; b) Each battery-powered device comes with its dedicated cable and wall charger. These two components function sometimes exclusively with each device and are not interchangeable between devices. This increases the cost of the device and the electronic-waste generated by the non-functional wall chargers and cables; c) The production of waterproof devices becomes more challenging due to the higher cost associated with the enclosure required around the input port of the battery-powered electronic device; and d) The use of a cable restricts the mobility of the user according to the length of the charging cable.

In order to avoid these disadvantages, several methods for WPT to recharge the battery of the electronic device without the use of a charging cable have been proposed in recent history.

Commercial wireless power transfer systems have mainly been driven by two organizations, the Wireless Power Consortium and the AirFuel Alliance. The Wireless Power Consortium created the Qi Standard to wirelessly charge consumer electronic devices using magnetic induction from a base station, usually a thin mat-like object, containing one or more transmitter inductors and a target device fitted with a receiving inductor. Qi systems may require close proximity of the transmitter and receiver devices, usually within a couple of millimeters to a couple of centimeters.

Wireless power transfer systems that function under the AirFuel Alliance principle use a resonant inductive coupling between the transmitter inductor and the receiver inductor to consequently charge the battery connected to the receiver device. The resonant coupling allows for the power to be transferred over greater distances.

According to a first aspect, the disclosure relates to an inductor arrangement for generating or receiving an electromagnetic field, the inductor arrangement comprising: a flat coil-shaped multi-layer substrate comprising a first conductive layer and a second conductive layer which are separated by an insulating layer, the flat coil-shaped multi-layer substrate being structured to form a planar inductor; and a third conductive layer and a fourth conductive layer deposited on the insulating layer at edges of the structured flat coil-shaped multi-layer substrate, wherein the first conductive layer, the second conductive layer, the third conductive layer and the fourth conductive layer are structured to form a tubular conductive layer, the tubular conductive layer enclosing the flat coil-shaped multi-layer substrate.

Such inductor arrangement can be used as both, transmitter and receiver resonator arrangement for wireless power transmission. The inductor arrangement has a high quality factor at a low thickness of the inductors. The thickness of the inductors may correspond to a thickness of the substrate which corresponds to a thickness of a common printed circuit board.

In particular, such inductor arrangement increases the overall system efficiency of the wireless power transfer link. Due to the added third and fourth conductive layers deposited on the insulating layer at the edges of the structured flat coil-shaped multi-layer substrate, the quality factor can be increased. Additionally, depending on the frequency of operation, having an inductor whose core is made of a non-conductive material diminishes the losses associated with the skin effect.

The inductor arrangement can be used as a transmitter or as a receiver or it can be used as a high quality factor inductor for other applications, not only wireless power transfer, for example, in nuclear magnetic resonance or magnetic resonance imaging, where one usually also looks for high quality factor inductors.

In an exemplary implementation of the inductor arrangement, the flat coil-shaped substrate is arranged to form at least one turn of the planar inductor.

This provides the advantage that the thickness of the inductor can be small since it is determined by the thickness of the substrate.

In an exemplary implementation of the inductor arrangement, the flat coil-shaped substrate is a planar substrate extending perpendicular to a principal direction of the generated or received electromagnetic field.

This provides the advantage that the inductor arrangement can deliver or receive an electromagnetic field to or from such a principal direction.

In an exemplary implementation of the inductor arrangement, the flat coil-shaped multi-layer substrate and the tubular conductive layer are based on a printed circuit board, the printed circuit board having an upper main face, a lower main face opposing the upper main face and lateral faces between the lower main face and the upper main face, the printed circuit board comprising the first conductive layer which is arranged at the upper main face and the second conductive layer which is arranged at the lower main face of the printed circuit board, wherein the third conductive layer and the fourth conductive layer are arranged at the lateral faces of the printed circuit board, the third and fourth conductive layers electrically connecting the first conductive layer with the second conductive layer.

This provides the advantage that the inductor arrangement can be efficiently manufactured by using PCB manufacturing processes.

In an exemplary implementation of the inductor arrangement, a thickness of the first conductive layer is different from a thickness of at least one of the second conductive layer, the third conductive layer and the fourth conductive layer; and/or a material of the first conductive layer is different from a material of at least one of the second conductive layer, the third conductive layer and the fourth conductive layer.

This provides the advantage that the electric and electromagnetic characteristics of the inductor arrangement can be flexible designed. In particular, each surface of the inductor arrangement can have different electric and electromagnetic characteristics.

In an exemplary implementation of the inductor arrangement, the coil-shaped flat multi-layer substrate comprises one or more bridges of non-conductive material, the bridges partially interrupting the tubular conductive layer.

This provides the advantage of added mechanical stability to the inductor arrangement by using the bridges.

In an exemplary implementation of the inductor arrangement, the bridges of non-conductive material provide a path for electrically conductive traces to pass through any of the following layers: the first conductive layer, the second conductive layer or an intermediate layer.

This provides the advantage of an efficient electrical connection of the inductor arrangement by using the conductive traces.

In an exemplary implementation of the inductor arrangement, the flat coil-shaped multi-layer substrate is arranged to form at least two turns of the planar inductor, the at least two turns being spaced apart from each other.

This provides the advantage that an inductivity of the inductor arrangement can be flexible designed. For example, a double turn inductor can have a higher inductivity than a single turn inductor.

In an exemplary implementation of the inductor arrangement, the at least two turns are arranged on a same conductive layer of the multi-layer substrate, a first turn of the at least two turns is arranged inside a second turn of the at least two turns; or a first turn of the least two turns is arranged next to a second turn of the at least two turns.

In the first case, the at least two turns may be formed, for example, by a spiral inductor with increasing diameter. In the second case, the at least two turns may be formed, for example, by a meander type inductor.

This provides the advantage that the at least two turns can be formed from the same conductive layer of a PCB.

In an exemplary implementation of the inductor arrangement, an end section of the first turn arranged inside the second turn forms a first terminal of the planar inductor for electrical connection of the planar inductor; and an end section of the second turn arranged outside the first turn forms a second terminal of the planar inductor for electrical connection of the planar inductor.

This provides the advantage that the inductor arrangement can be efficiently connected to an electrical circuit, e.g., a Tx circuit or an Rx circuit as shown in FIG. 11, by using the two terminals.

In an exemplary implementation of the inductor arrangement, the inductor arrangement comprises: a second substrate comprising a first conductive track with a first contact pad and a second contact pad, wherein the second substrate is arranged above or below the flat coil-shaped multi-layer substrate, the first contact pad of the first conductive track contacting the first terminal of the planar inductor to provide an electrical connection from an inside of the planar inductor to an outside of the planar inductor.

This provides the advantage that the inductor arrangement can be efficiently connected to an electrical circuit by using a second substrate for providing the electrical connection in a layer above or below the substrate.

In an exemplary implementation of the inductor arrangement, the second substrate comprises a second conductive track with a first contact pad and a second contact pad, the first contact pad of the second conductive track contacting the second terminal of the planar inductor, wherein the first conductive track and the second conductive track provide an electrical connection of the planar inductor to an electrical circuitry on the second substrate.

This provides the advantage that the inductor arrangement can be efficiently connected to an electrical circuitry on the second substrate.

In an exemplary implementation of the inductor arrangement, the inductor arrangement comprises: a second substrate formed from an extension of the flat coil-shaped multi-layer substrate, the second substrate being arranged outside of the planar inductor; wherein the coil-shaped flat multi-layer substrate comprises a conductive trace electrically connecting the first terminal on the inside of the planar inductor to an electrical circuitry on the second substrate.

This provides the advantage that a single substrate can be used for forming the inductor on the substrate and an electrical circuitry for connection of the inductor on an extension of the substrate. Thus, a fabrication of the inductor arrangement can be efficiently performed.

In an exemplary implementation of the inductor arrangement, the coil-shaped flat multi-layer substrate comprises one or more bridges of non-conductive material formed to provide a path for the conductive trace electrically conductive connecting the first terminal on the inside of the planar inductor to the electrical circuitry on the second substrate.

This provides the advantage that a single substrate can be used for forming the inductor on the substrate and the electrical circuitry on the extension of the substrate. The bridges can be formed in the multi-layer substrate.

The inductor arrangement can be used as a transmitter, a receiver or as a relay device.

In an exemplary implementation of the inductor arrangement, the flat coil-shaped multi-layer substrate has one of the following shapes: a circular shape, an oval shape, a meander shape, or any other polygonal shape.

This provides the advantage that the inductor arrangement can be flexible designed based on different substrate shapes.

According to a second aspect, the disclosure relates to a wireless power transmission system, comprising: at least one inductor arrangement according to the first aspect described above.

This provides the advantage that such wireless power transmission system can be easily manufactured by using the inductor arrangement described above. The wireless power transmission system can provide high quality transmission due to the high quality factor of the inductor arrangement. Such wireless power transmission system increases the overall system efficiency of the wireless power transfer link. Losses associated with the skin effect can be diminished.

In an exemplary implementation of the wireless power transmission system, the wireless power transmission system comprises a transmitter resonator formed by the at least one inductor arrangement.

Such transmitter resonator formed by the inductor arrangement provides the same advantages for the wireless power transmission system as described above for the inductor arrangement.

In an exemplary implementation of the wireless power transmission system, the wireless power transmission system comprises a relay resonator formed by the at least one inductor arrangement.

Such relay resonator formed by the inductor arrangement provides the same advantages for the wireless power transmission system as described above for the inductor arrangement.

In an exemplary implementation of the wireless power transmission system, the wireless power transmission system comprises a receiver resonator formed by the at least one inductor arrangement.

Such receiver resonator formed by the inductor arrangement provides the same advantages for the wireless power transmission system as described above for the inductor arrangement.

In an exemplary implementation of the wireless power transmission system, the wireless power transmission system comprises a plurality of inductor arrangements arranged in a three-dimensional array.

Such a three-dimensional array of inductor arrangements provides the same advantages for the wireless power transmission system as described above for the inductor arrangement.

According to a third aspect, the disclosure relates to a method for producing an inductor arrangement for generating or receiving an electromagnetic field, the method comprising: providing a multi-layer substrate comprising a first conductive layer and a second conductive layer which are separated by an insulating layer; structuring the first conductive layer and the second conductive layer to form a planar inductor; removing substrate material from edges of the structured first and second conductive layers to provide a flat coil-shaped multi-layer substrate; and depositing a third and a fourth conductive layer on the insulating layer at the edges of the structured first and second conductive layers, the third and fourth conductive layers electrically connecting the structured first and second conductive layers to form a tubular conductive layer, the tubular conductive layer enclosing the flat coil-shaped multi-layer substrate.

Such a method enables producing inductors with high quality factor and hence increasing the overall system efficiency of the wireless power transfer link. The added third and fourth conductive layers deposited on the insulating layer at the edges of the structured flat coil-shaped multi-layer substrate can be easily manufactured by PCB processes. The method allows producing inductors whose core are made of a non-conductive material, thereby diminishing the losses associated with the skin effect.

In an exemplary implementation of the method, structuring the first conductive layer and the second conductive layer and removing substrate material are performed in a single processing step.

This provides the advantage that manufacturing steps can be saved, thereby simplifying the production process.

In an exemplary implementation of the method, the first conductive layer and the second conductive layer are structured to form at least two turns of a planar inductor, wherein the substrate material is removed outside, inside and in between the at least two turns of the planar inductor.

This provides the advantage that an inductivity of the inductor arrangement can be flexible designed by this method. For example, a double turn inductor can have a higher inductivity than a single turn inductor.

### BRIEF DESCRIPTION OF THE DRAWINGS

Further embodiments of the disclosure will be described with respect to the following figures, in which:

FIG. 1 shows a schematic diagram of an inductor arrangement 200 according to the disclosure;

FIGS. 2A and 2B shows a schematic diagram illustrating a manufacturing method for manufacturing an inductor arrangement according to the disclosure;

FIGS. 3A and 3B show schematic diagrams illustrating exemplary implementations of the inductor arrangement;

FIGS. 4A to 4E show schematic diagrams illustrating an example of the inductor arrangement having multiple turns;

FIGS. 5A to 5C show schematic diagrams illustrating exemplary implementations of the inductor arrangement for the connection of the inner node with further circuitry;

FIG. 6 shows a schematic diagram illustrating an exemplary implementation of the inductor arrangement for the connection between the inner node of the inductor with multiple turns with further circuitry located on the outside of the turns of the inductor;

FIGS. 7A to 7C show a schematic diagram illustrating an embodiment of the inductor arrangement that shows how to perform the electrical connection of an inductor;

FIG. 8 shows a schematic diagram illustrating an exemplary implementation of the inductor arrangement for the connection between the inner node of the inductor with multiple turns with further circuitry located on the outside of the turns of the inductor;

FIG. 9 shows a schematic diagram illustrating an exemplary inductor arrangement fabricated by the method shown in FIGS. 2A-2B;

FIG. 10 shows a schematic diagram illustrating an exemplary implementation of the inductor arrangement with multiple turns fabricated by the method shown in FIGS. 2A-2B;

FIG. 11 shows a schematic diagram illustrating a basic model for a two-coil WPT system;

FIG. 12 shows a schematic diagram illustrating an exemplary inductor arrangement fabricated by the method shown in FIGS. 2A-2B; and

FIG. 13 shows a schematic diagram illustrating an exemplary inductor arrangement fabricated by the method shown in FIGS. 2A-2B.

### DETAILED DESCRIPTION OF EMBODIMENTS

In the following detailed description, reference is made to the accompanying drawings, which form a part thereof, and in which is shown by way of illustration specific aspects in which the disclosure may be practiced. It is understood that other aspects may be utilized and structural or logical changes may be made without departing from the scope of the disclosure. The following detailed description, therefore, is not to be taken in a limiting sense, and the scope of the disclosure is defined by the appended claims.

It is understood that comments made in connection with a described method may also hold true for a corresponding device or system configured to perform the method and vice versa. For example, if a specific method step is described, a corresponding device may include a unit to perform the described method step, even if such unit is not explicitly described or illustrated in the figures. Further, it is understood that the features of the various exemplary aspects described herein may be combined with each other, unless specifically noted otherwise.

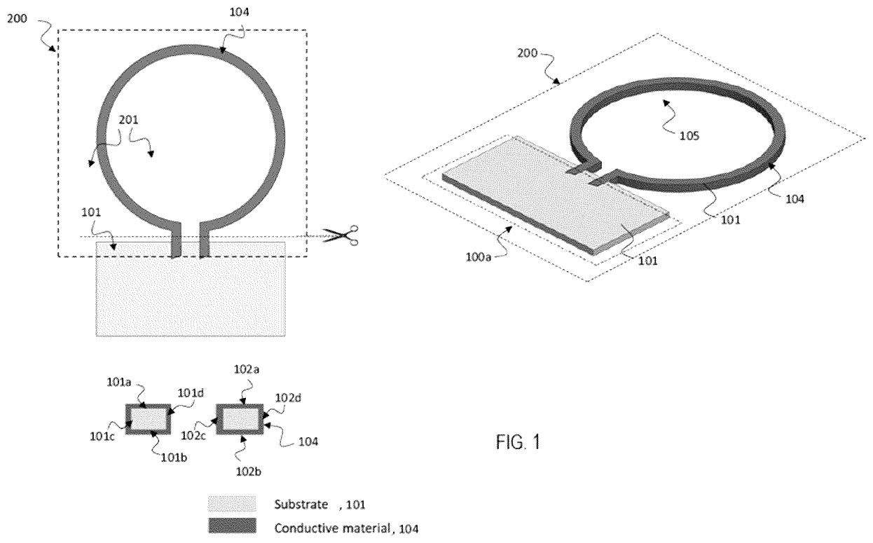

FIG. 1 shows a schematic diagram of an inductor arrangement 200 according to the disclosure.

The inductor arrangement 200 forms a substantially planar inductor 200 comprising: a printed-circuit-board compatible substrate 101; conductive materials 102 on the top and bottom layers of the substrate forming at least one turn to produce the inductor 200; a space without substrate material 201 on the outside and inside of the at least one turn and on the outside, inside, and in between turns of an inductor featuring multiple turns; electrodeposition of conductive material 104; wherein the electrodeposited material electrically connects the top and bottom conducting layers forming a pipe-like conductive structure filled with the substrate material 101.

Although not depicted in FIG. 1, the conductive material can have different thicknesses for the top, bottom and the electrodeposited portions. The material of the portions found on the top, bottom or the electroplated may be implemented using the same conductive material or different. Some possible substrate materials include but are not limited to glass fiber, glass-epoxy, paper phenolic, ceramic or flexible substrates.

The inductor arrangement 200 can be used for generating or receiving an electromagnetic field. The inductor arrangement 200 can be described as follows.

The inductor arrangement 200 comprises a flat coil-shaped multi-layer substrate 101 comprising a first conductive layer 102a and a second conductive layer 102b which are separated by an insulating layer. The flat coil-shaped multi-layer substrate 101 is structured to form a planar inductor.

The inductor arrangement 200 comprises a third conductive layer 102c and a fourth conductive layer 102d deposited on the insulating layer at edges of the structured flat coil-shaped multi-layer substrate 101.

The first conductive layer 102a, the second conductive layer 102b, the third conductive layer 102c and the fourth conductive layer 102d are structured to form a tubular conductive layer 104. This tubular conductive layer 104 is enclosing the flat coil-shaped multi-layer substrate 101.

The flat coil-shaped substrate 101 may be arranged to form at least one turn 105 of the planar inductor.

The flat coil-shaped substrate 101 may be a planar substrate extending perpendicular to a principal direction of the generated or received electromagnetic field.

The inductor arrangement 200 may be manufactured with standard PCB technology as described in the following. Depending on the operating frequency and parameters like the width of the conductive traces or the spacing between them can render an increase in quality factor.

The flat coil-shaped multi-layer substrate 101 and the tubular conductive layer 104 may be based on a printed circuit board. As can be seen from FIG. 1, the printed circuit board has an upper main face 101a, a lower main face 101b opposing the upper main face 101a and lateral faces 101c, 101d between the lower main face 101b and the upper main face 101a.

The printed circuit board comprises the first conductive layer 102a which is arranged at the upper main face 101a and the second conductive layer 102b which is arranged at the lower main face 101b of the printed circuit board. The third conductive layer 102c and the fourth conductive layer 102d are arranged at the lateral faces 101c, 101d of the printed circuit board. The third 102c and fourth 102d conductive layers are electrically connecting the first conductive layer 102a with the second conductive layer 102b.

A thickness of the first conductive layer 102a can be different from a thickness of at least one of the second conductive layer 102b, the third conductive layer 102c and the fourth conductive layer 102d.

A material of the first conductive layer 102a can be different from a material of at least one of the second conductive layer 102b, the third conductive layer 102c and the fourth conductive layer 102d.

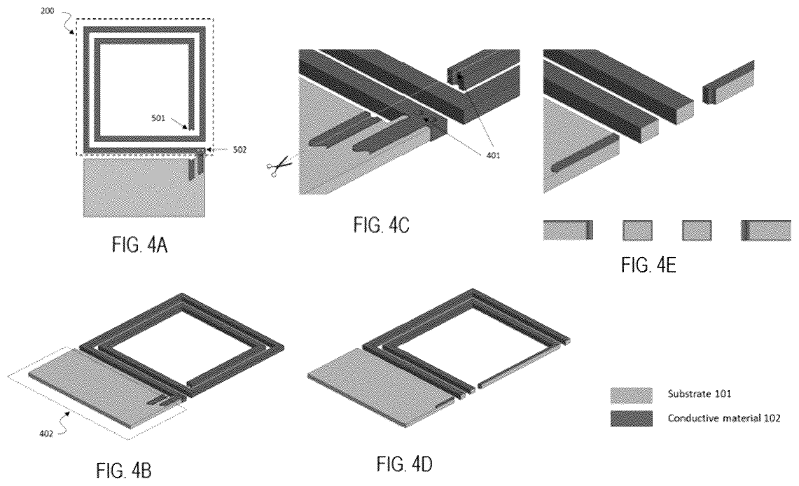

The flat coil-shaped multi-layer substrate 101 can be arranged to form at least two turns 105 of the planar inductor, the at least two turns 105 being spaced apart from each other, e.g., as described below with respect to FIGS. 4 to 10 and 12 to 13.

The at least two turns 105 may be arranged on a same conductive layer of the multi-layer substrate 101.

A first turn of the least two turns 105 can be arranged inside a second turn of the at least two turns 105, e.g., as described below with respect to FIGS. 4 to 10 and 12 to 13.

A first turn of the least two turns 105 can be arranged next to a second turn of the at least two turns 105, e.g., as described below with respect to FIGS. 4 to 10 and 12 to 13.

An end section of the first turn arranged inside the second turn can form a first terminal of the planar inductor for electrical connection of the planar inductor, e.g., as described below with respect to FIGS. 4 to 10 and 12 to 13. An end section of the second turn arranged outside the first turn can form a second terminal of the planar inductor for electrical connection of the planar inductor, e.g., as described below with respect to FIGS. 4 to 10 and 12 to 13.

The inductor arrangement 200 can comprise a second substrate comprising a first conductive track with a first contact pad and a second contact pad, e.g., as described below with respect to FIGS. 4 to 10 and 12 to 13. This second substrate may be arranged above or below the flat coil-shaped multi-layer substrate 101. The first contact pad of the first conductive track may contact the first terminal of the planar inductor to provide an electrical connection from an inside of the planar inductor to an outside of the planar inductor.

The second substrate may comprise a second conductive track with a first contact pad and a second contact pad. The first contact pad of the second conductive track may contact the second terminal of the planar inductor. The first conductive track and the second conductive track may provide an electrical connection of the planar inductor to an electrical circuitry on the second substrate, e.g., as described below with respect to FIGS. 4 to 10 and 12 to 13.

The inductor arrangement 200 may comprise a second substrate formed from an extension of the flat coil-shaped multi-layer substrate 101. This second substrate can be arranged outside of the planar inductor. The coil-shaped flat multi-layer substrate 101 may comprise a conductive trace electrically connecting the first terminal on the inside of the planar inductor to an electrical circuitry on the second substrate.

The coil-shaped flat multi-layer substrate 101 may comprise one or more bridges of non-conductive material formed to provide a path for the conductive trace electrically conductive connecting the first terminal on the inside of the planar inductor to the electrical circuitry on the second substrate, e.g., as described below with respect to FIGS. 4 to 10 and 12 to 13.

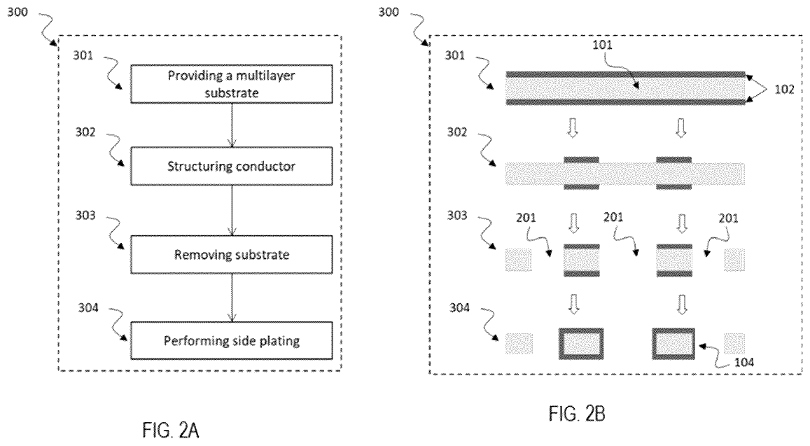

FIGS. 2A-2B show a schematic diagram illustrating a manufacturing method for manufacturing an inductor arrangement according to the disclosure.

The diagram demonstrates how the inductor 200 or inductor arrangement 200, respectively shown in FIG. 1 can be manufactured. Such a manufacturing method 300 comprises the steps of providing a multilayer substrate 301 further comprising: a printed-circuit-board compatible substrate 101 with multiple electrically conductive layers 102; structuring 302 at least two of these conducting layers in implementations where there are two conducting layers, to produce a first inductor trace 102 on a first layer, e.g. on the top layer overlaying a second inductor trace 102 found on a second layer, e.g. on the bottom layer; removing 302 substrate material 101 on the sides 201 of the conducting traces of inductor 200. In some implementations the inductor 200 might have multiple turns, therefore the removal of the substrate material will happen on the outside, inside and in between the turns of the inductor; an electrodeposition 304 of conductive material; wherein the electrodeposited material 104 on the edge of the substrate electrically connects the first inductor trace on the first layer and the second inductor trace on the second layer forming a pipe-like conductive structure filled with the substrate material 101.

The structuring step 302 of the conductor is done in some implementations employing photolithographic processes usual to printed circuit board technology and in other implementations it might be performed using mechanical structuring, for example, both the conducting and the substrate material might be removed using a milling process.

In particular, the method 300 described above for producing an inductor arrangement 200 as shown in FIG. 1 for generating or receiving an electromagnetic field, can defined by the following process steps:
1) providing 301 a multi-layer substrate 101 comprising a first conductive layer and a second conductive layer which are separated by an insulating layer.
2) structuring 302 the first conductive layer and the second conductive layer to form a planar inductor.
3) removing 303 substrate material from edges of the structured first and second conductive layers to provide a flat coil-shaped multi-layer substrate 101.
4) depositing 304 a third and a fourth conductive layer on the insulating layer at the edges of the structured first and second conductive layers, the third and fourth conductive layers electrically connecting the structured first and second conductive layers to form a tubular conductive layer 104, the tubular conductive layer 104 enclosing the flat coil-shaped multi-layer substrate 101.

The structuring 302 of the first conductive layer and the second conductive layer and the removing 303 of substrate material can be performed in a single processing step.

The first conductive layer and the second conductive layer may be structured to form at least two turns 105 of a planar inductor, e.g., as shown in FIGS. 4 to 10 and 12 to 13. The substrate material can be removed 303 outside, inside and in between the at least two turns of the planar inductor.

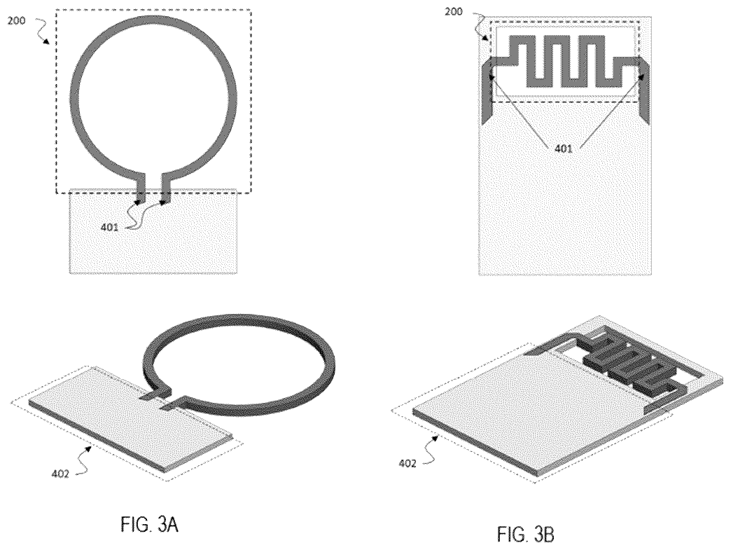

FIGS. 3A and 3B show schematic diagrams illustrating exemplary implementations of the inductor arrangement 200 of FIG. 1.

In particular, FIGS. 3A and 3B show some implementations of the disclosed inductor arrangement 200, or simply referred to as inductor 200. FIG. 3A shows an inductor with a single turn and FIG. 3B shows an inductor structured as a meander as an example. Such inductors with a single turn or non-concentric turns present usually a small inductance when compared to those with multiple turns extending from the inside to the outside that occupy more or less the same footprint. Inductors with a reduced inductance may be used in high frequency applications like high-frequency wireless power transmission or in magnetic resonance imaging.

Note as well that FIGS. 3A and 3B and its sub-figures exemplify that because of the single turn or meander nature of the inductors, both of the connection ports to the inductors are easily accessible, for example, the ports 401 are featured having a direct connection to possible circuitry 402.

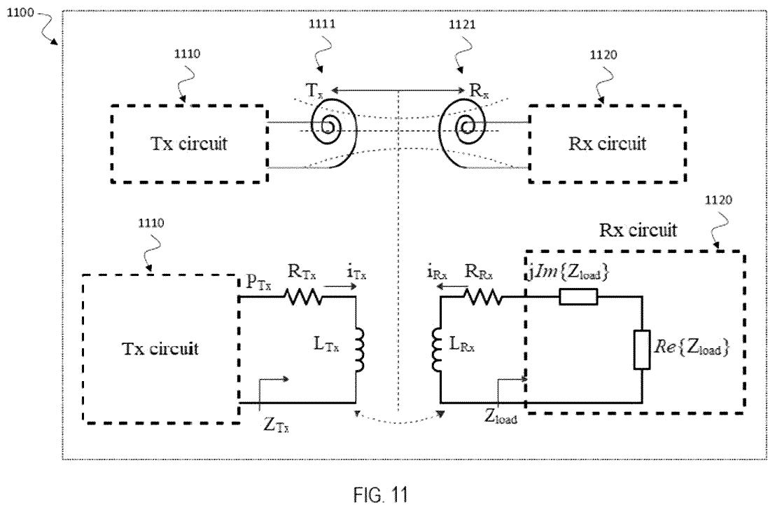

In contrast, FIGS. 4A to 4E depict an example of an inductor 200 having multiple turns fabricated with the method 300 described in this disclosure, see FIGS. 2A-2B. FIG. 4A shows the top view, FIG. 4B an isometric view, FIG. 4C a zoom-in view of the input and output nodes of the fabricated inductor. FIG. 4D is a cross section view with a zoomed-in view in FIG. 4E that shows the conductor and substrate materials in detail. Note that there exists the possibility of having a direct connection between the inductor's external node 502 and additional circuitry 402 found on the same substrate 101 with which the inductor 200 was produced. However, the connection port 501, found on the inside of the inductor may need to be connected as well to the external circuitry 402 in most implementations. For example, inductor 200 of FIGS. 4A to 4E may represent the transmitter or the receiver inductors of the wireless power transmission system depicted in FIG. 11 and described below. For this particular application, both connection ports 501 and 502 may need to be accessible to the user.

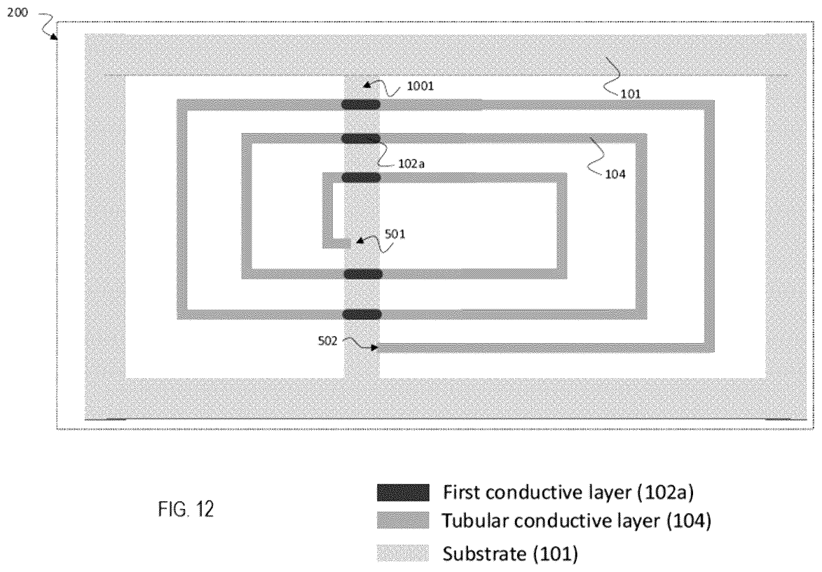

FIG. 12 shows a schematic diagram illustrating an exemplary implementation of a multiple-turn inductor arrangement 200 having a few bridges 1001 of non-removed substrate material between the turns of the inductor to provide mechanical stability.

The electrodeposition of conductive material and the turns of inductor 200 are interrupted in the bridge portions but remains continuous on the bottom, top or both conductive layers, ensuring a continuous electrical path of the inductor. The resistance at these small portions is increased because they have less conductive material but this configuration is providing the inductor 200 with an increased mechanical stability.

FIG. 12 shows the bridges 1001, connection ports 501, 502, substrate 101, tubular conductive layer 104 and first conductive layer 102a as described above.

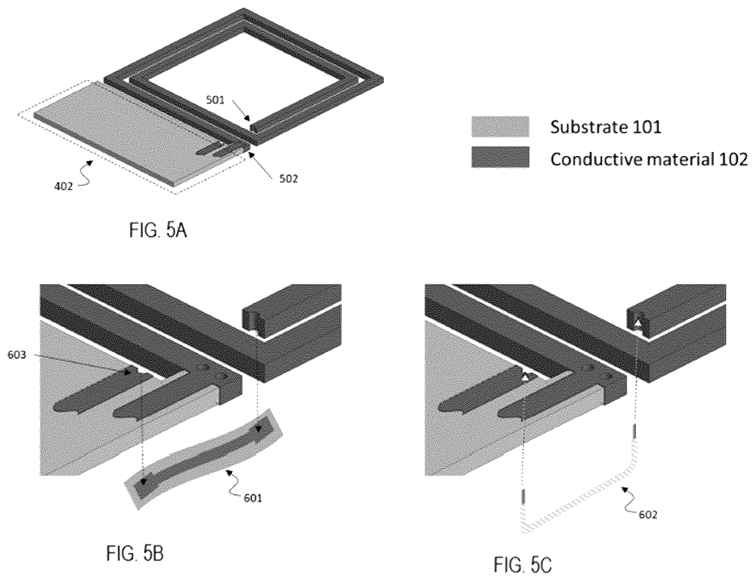

FIGS. 5A to 5C show schematic diagrams illustrating exemplary implementations of the inductor arrangement for the connection of the inner node with further circuitry.

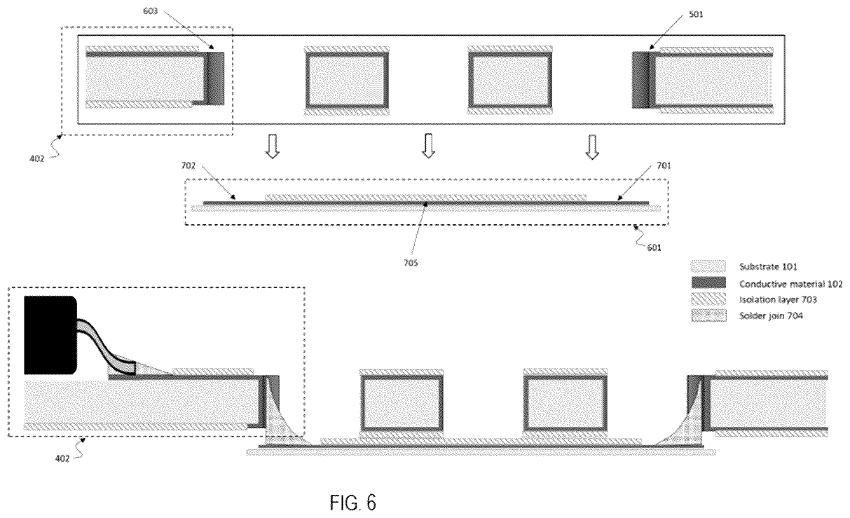

This disclosure presents multiple ways to connect to the port 501 found on the inside of a multiple-turn inductor 200. FIGS. 5B to 5C exemplify two possible implementations for the connection of the inner node 501 of the inductor depicted in FIGS. 4A-4E with further circuitry 402 within the same substrate as the inductor. In this case, FIG. 5B shows an additional substrate 601 with a single conductive track and two contact pads. One of the contact pads to be soldered to the inner node of the inductor 501 and the second pad to be soldered to a contact trace or pad 603 located on the substrate portion containing additional circuitry 402. FIG. 6 further clarifies this possible implementation. Similarly, FIG. 5C shows a conductive cable 602 to be connected between 501 and 603.

FIG. 6 shows a possible connection between the inner node 501 of the inductor 200 with multiple turns depicted in FIG. 4 with further circuitry 402 located on the outside of the turns of inductor 200. This configuration uses an additional substrate 601 with a single track 705 of conductive materials, two contact pads 701-702 and isolation layers. The additional substrate 601 can be implemented with substrate materials like but not limited to glass fiber, glass-epoxy, paper phenolic, ceramic or flexible substrates.

One of the contact pads 701 can be, for example, soldered to the inner node 501 of inductor 200 and the second contact pad 702 is to be soldered to the contact trace or pad 603 located on the substrate portion containing the additional circuitry 402. Note that in this particular embodiment, the substrate of the inductor 200 and the substrate containing the additional circuitry is the same. Solder joints 704 and isolation layers 703 are also depicted to ensure electrical connection and avoid any short circuit between conductive structures.

In some other implementations there is no need to have solder joints, as the electrical contact can be done by overlapping the corresponding conductive structures and pressing them mechanically to ensure a proper electrical connection.

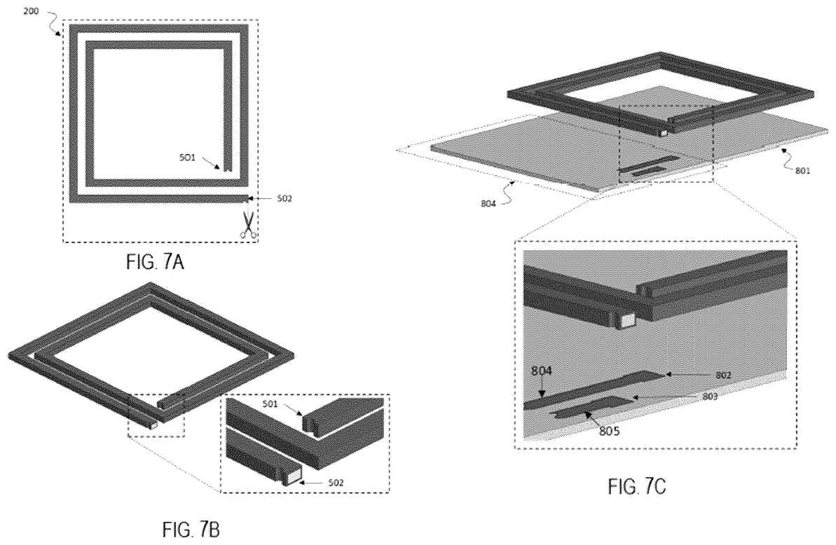

So far, the presented embodiments have shown possible ways to connect the nodes 501 and 502 of inductor 200 to additional circuitry found on the same substrate from which inductor 200 was produced. In contrast, FIGS. 7A to 7C is an embodiment that shows how to perform the electrical connection of an inductor 200, depicted in FIG. 4A, fabricated with the method described in this disclosure, see FIGS. 2A-2B, and found on an independent substrate 101 with further circuitry 804 found on a second substrate 801.

In particular, FIGS. 7A to 7C show a schematic diagram illustrating an embodiment of the inductor arrangement that shows how to perform the electrical connection of an inductor.

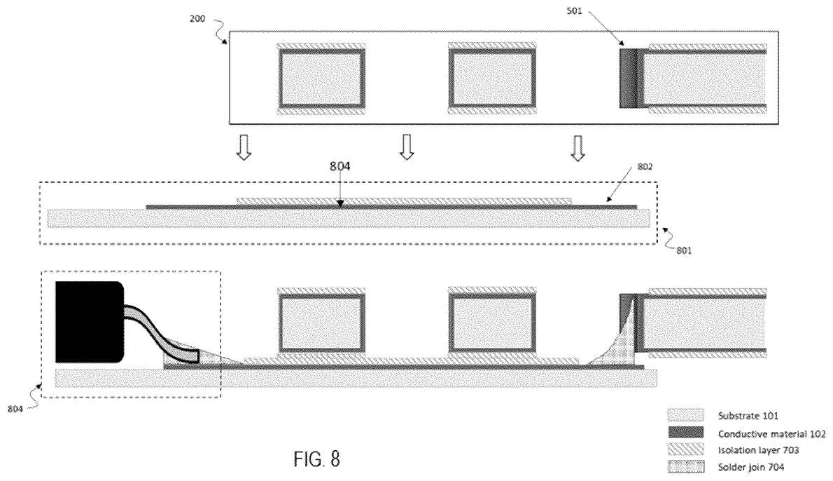

FIG. 7B shows an isometric and zoomed-in view of both input and output nodes 501 and 502 of the inductor 200, for clarity. Additionally, FIG. 7C shows two contact pads 802 and 803 each one electrically connected to a conductive trace in substrate 801. One of the contact pads 802 is to be soldered or mechanically pressed to the inner node 501 of the inductor and the second contact pad 803 is to be soldered to outer node 502 of the inductor. FIG. 8 further develops this connection solution. Note that the isolation layer 703 that ensures an electrical isolation between most-outer turns of the inductor 200 depicted in FIGS. 7A-7C has been omitted for clarity, but it is clearly shown in FIG. 8.

FIG. 8 shows a possible connection between the inner node 501 of the inductor 200 with multiple turns depicted in FIGS. 7A to 7C with further circuitry 804 located on the outside of the turns of inductor 200 in an additional substrate 801. This configuration uses an additional substrate 801 with two tracks of conductive materials electrically connected to two contact pads 802 and 803 and isolation layers. The additional substrate 801 can be implemented with substrate materials like but not limited to glass fiber, glass-epoxy, paper phenolic, ceramic or flexible substrates.

The cross-section view is located to show one of the contact pads 802 to be soldered to the inner node 501 of the inductor. Solder joints 704 and isolation layers 703 are also depicted to ensure electrical connection and avoid any short circuit between conductive structures.

One of the contact pads 802 can be, for example, soldered to the inner node 501 of inductor 200 and the second contact pad 803 is to be soldered to node 502 of inductor 200. Note that in this particular embodiment, the substrate of the inductor 200 and the substrate 801 containing the additional circuitry is different.

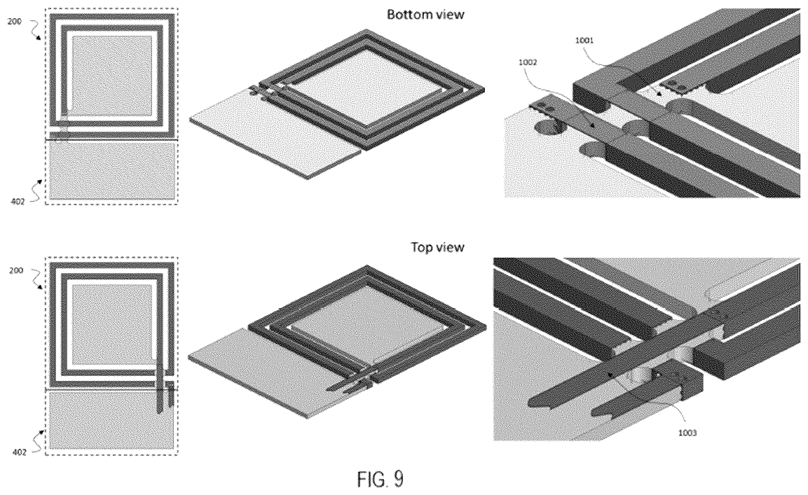

FIG. 9 shows a schematic diagram illustrating an exemplary inductor arrangement fabricated by the method shown in FIGS. 2A-2B.

In particular, FIG. 9 depicts an inductor 200 with multiple turns fabricated with the method described in this disclosure. FIG. 9 is an exemplary embodiment on how to perform a direct connection to both inner 501 and outer 502 nodes of inductor 200 with further circuitry 402 located on the same substrate 101 as the one from which inductor 200 was manufactured and without the use of any additional components like cables or substrates other than the conductive traces 1002, 1003 that were fabricated during the same fabrication process as the inductor 200.

A few bridges 1001 of non-removed substrate material between the turns of inductor 200 may be required for this embodiment. The bridges will provide stability to the inductor itself and a path for a trace 1003 located on the top layer to run all the way through from the inner side to the outer side of the inductor.

The electrodeposition of conductive material and the turns of inductor 200 are interrupted in the bridge portions shown on the top view but remains continuous on the bottom layer 1002, shown on the bottom view, ensuring a continuous electrical path of the inductor. The resistance at these small portions is increased because they have less conductive material but they avoid utilization of external components and having an increased overall thickness due to the additional substrate or conductive material used. Moreover, this configuration opens up the opportunity to place additional circuitry on the substrate portion found inside the inductor 200 in some other implementations.

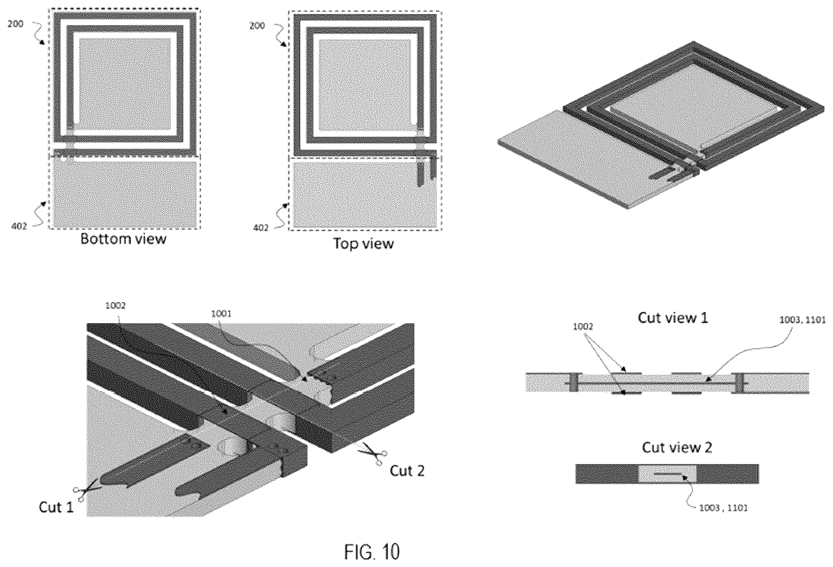

FIG. 10 shows a schematic diagram illustrating an exemplary implementation of the inductor arrangement with multiple turns fabricated by the method shown in FIGS. 2A-2B.

In particular, FIG. 10 depicts an inductor 200 with multiple turns fabricated with the method described in this disclosure. FIG. 10 is an exemplary embodiment on how to perform a direct connection to both inner 501 and outer 502 nodes of the inductor with further circuitry 402 located on the same substrate 101 as the one from which inductor 200 was manufactured and without the use of any additional components like cables or substrates other than the conductive traces 1002, 1003 that were fabricated during the same fabrication process as the inductor 200.

A few bridges 1001 of non-removed substrate material between turns may be required for this embodiment as well. The bridges will provide stability to the inductor 200 and a path for a trace 1003 on a third layer 1101 to run all the way through from the inner to the outer of the inductor.

The electrodeposition of conductive material is interrupted in the bridge portions but remains continuous on top and bottom layers 1002, ensuring a continuous electrical path of the inductor. The resistance at these small portions is increased because they have less conductive material but they avoid utilization of external components and having an increased overall thickness due to the additional substrate or conductive material used. Moreover, this configuration opens up the opportunity to place additional circuitry on the substrate portion found inside the inductor 200 in some other implementations.

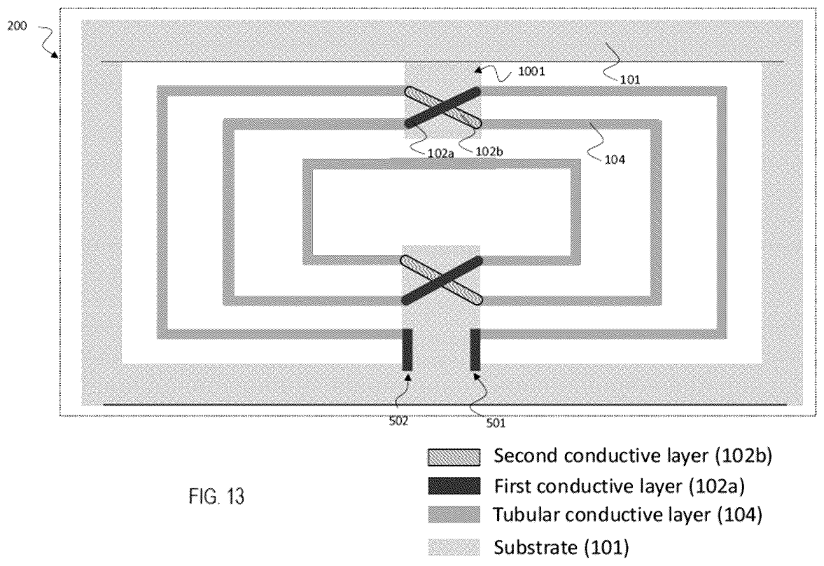

FIG. 13 shows a schematic diagram illustrating an exemplary implementation of the inductor arrangement with multiple turns fabricated by the method shown in FIGS. 2A-2B.

In particular, FIG. 13 depicts an inductor 200 in the shape of a planar spiral wound from the outside inwards and then from the inside outwards while keeping the same direction of current flow. The winding configuration of this implementation allows for both of the connection nodes 501 and 502 of the inductor to be readily connected to additional circuitry.

FIG. 13 shows a schematic diagram illustrating an exemplary implementation of a multiple-turn inductor arrangement 200 having a few bridges 1001 of non-removed substrate material between the turns of the inductor to provide mechanical stability. The electrodeposition of conductive material and the turns of inductor 200 are interrupted in the bridge portions but remains continuous on the first conductive layer (102a), the second conductive layer (102b) or both conductive layers, ensuring a continuous electrical path of the inductor. The resistance at these small portions is increased because they have less conductive material but this configuration is providing the inductor 200 with an increased mechanical stability. The bridges 1001 create a path for the intersection between the windings going in and windings going out according to the winding configuration while avoiding electrical contact.

FIG. 13 shows the bridges 1001, connection ports 501, 502, substrate 101, tubular conductive layer 104, first conductive layer 102a and second conductive layer 102b as described above.

To better illustrate the above-described benefit, a basic model for a WPT system 1100, in particular a 2-coil WPT system is shown in FIG. 11 and serves to obtain an expression for the essential performance metric, the wireless power link efficiency, η_{Link}. In actuality, each inductor is made up of its desired characteristic, its self-inductance, as well as a few undesirable components that can be grouped into resistive and capacitive components. For the purpose of simplicity, no parasitic capacitors of the transmitter and receiver inductors 1111, 1121 are considered in this model. The lumped parasitic resistances of the inductances L_{Tx} and L_{RX}, which model the losses in their windings, are R_{Tx} and R_{Rx}, respectively. The transmitter 1111 and receiver 1121 inductors, separated by an arbitrary distance D_{Tx-RX} have a mutual inductance of M_{Tx-RX}, which is determined by their geometry, relative position and orientation.

The input impedance of the Rx-circuit 1120 is denoted in this figure as Z_{load}, which may be composed by a real part and an imaginary part. Z_{load} can represent, for instance, a load connected directly to the receiver resonator or it might arise from a subsequent part of the power conversion chain in the receiver device, for example from a rectifier circuit and a DC-DC converter.

When considering that the wireless power transmission between the transmitter and the receiver resonators happens in the near-field of the transmitter, there are no radiation effects included. Therefore, all the losses in the system occur due to the parasitic resistances of the transmitter and the receiver inductors, R_{TX} and R_{RX}. In this manner, the power supplied by the transmitter circuit 1110 (Tx-circuit) is delivered to the receiver circuit 1120 (Rx-circuit) affected by the inductors' mutual inductance and it is dissipated as heat in the equivalent series resistances of the inductors.

The efficiency on the receiver inductor shown in (1) can be defined as the ratio between the power delivered to the load impedance Z_{load}, denoted as P_{load} and the total power dissipated in the receiver's inductor resistance R_{RX}, that is:

$${η}_{{L}_{R x}} = \frac{Re \{ {Z}_{l o a d} \} {i}_{R x}^{2} / 2}{Re \{ {Z}_{l o a d} \} {i}_{R x}^{2} / 2 + {R}_{R x} {i}_{R x}^{2} / 2} \qquad ( 1 )$$

where, i_{Rx} is the peak current flowing through the loaded receiver inductor and Re {Z_{load}} is the real part of the load impedance Z_{load}. Multiplying both sides of the fraction by the term ωL_{Rx}, where w represents the frequency of operation leads to expressing the result as shown in (4), in terms of the quality factor of the receiver inductor:

$${Q}_{R x} = \frac{ω {L}_{R x}}{{R}_{R x}} , \qquad ( 2 )$$

and the loaded quality factor of the receiver circuit:

$${Q}_{L} = \frac{ω {L}_{R x}}{Re \{ {Z}_{l o a d} \}} \qquad ( 3 )$$

$${η}_{{L}_{R x}} = \frac{{Q}_{R x}}{{Q}_{R x} + {Q}_{L}} \qquad ( 4 )$$

The impedance seen by the transmitter, Z_{TX}, according to FIG. 11 can be calculated using Kirchhoff's laws including the effect of the mutual inductance, once can calculate this impedance as:

$$\begin{matrix}{V}_{{L}_{T x}} = ( {R}_{T x} + j ω {L}_{T x} ) {i}_{T x} + j ω {M}_{T x - R x} {i}_{R x} \\ {i}_{R x} = \frac{- {i}_{T X} j {M}_{T x - R x}}{{R}_{R x} + j ω {L}_{R x} + {Z}_{l o a d}}\end{matrix} \} ⇒ \qquad ( 5 )$$

$$⟹ {Z}_{T x} = \frac{{V}_{{L}_{T x}}}{{i}_{T x}} = ( {R}_{T x} + j ω {L}_{T x} ) + \frac{{ω}^{2} {M}_{T x - R x}^{2}}{{\underbrace{{R}_{R x} + j ω {L}_{R x} + {Z}_{l o a d}}}_{{Z}_{Rx - {Tx}_{ref}}}}$$

where, i_{Tx} is the peak current flowing through the transmitter circuit. It can be observed then from FIGS. 11 and (5), that the input impedance seen by the transmitter circuit, Z_{TX}, is a series combination of the R_{Tx} and L_{Tx} and a reflected impedance from the Rx-inductor, Z_{Rx-Tx}_{_{ref}}, defined in (5). The Tx-inductor efficiency is the power delivered to the real part of the reflected impedance, Re {Z_{Rx-Tx}_{_{ref}}}, the power transfer to the Rx-inductor, divided by the total power dissipated in R_{Tx} and Re {Z_{Rx-Tx}_{_{ref}}}, that is:

$${η}_{{L}_{T x}} = \frac{Re \{ {Z}_{R x - T {x}_{r e f}} \} {i}_{T x}^{2} / 2}{Re \{ {Z}_{R x - T {x}_{r e f}} \} {i}_{T x}^{2} / 2 + {R}_{T x} {i}_{T x}^{2} / 2} \qquad ( 6 )$$

The maximum Tx-inductor efficiency is obtained when real part of the reflected impedance is maximized, that is when the imaginary part of jωL_{Rx}+Z_{Rx-Tx}_{_{ref}} is equal to zero, which indicates that the Rx-inductor is at resonance. In the case of a resonant Rx-inductor, an expression for this reflected resistance can be proven to be:

$${Z}_{R x - T {x}_{r e f}} = \frac{{ω}^{2} {\overbrace{{k}_{T x - R x}^{2} {L}_{Tx} {L}_{Rx}}}^{{M}_{Tx} - {Rx}^{2}}}{{R}_{R x} + j ω {L}_{R x} + j Im \{ {Z}_{l a o d} \} + Re \{ {Z}_{l o a d} \}} ⇒ \qquad ( 7 )$$

$$⇒ {Z}_{R x - T {x}_{r e f}} = Re \{ {Z}_{R x - T {x}_{r e f}} \} = {R}_{R x - T {x}_{r e f}} = \frac{{ω}^{2} {k}_{T x - R x}^{2} {L}_{Tx} {L}_{Rx}}{{R}_{R x} + Re \{ {Z}_{l o a d} \}}$$

Using equations (2) and (3) and defining the Tx-inductor quality factor as:

$${Q}_{T x} = \frac{ω {L}_{T x}}{{R}_{T x}} , \qquad ( 8 )$$

the reflected resistances to the transmitter given in (7) can be rewritten in terms of those quality factors as follows:

$$Re \{ {Z}_{R x - T {x}_{r e f}} \} = {R}_{R x - T {x}_{r e f}} = {k}_{T x - R x}^{2} {Q}_{T x} \frac{\overbrace{{Q}_{Rx} {Q}_{L}}^{{Q}_{Rx - L}}}{{Q}_{L} + {Q}_{Rx}} {R}_{T x} = {k}_{T x - R x}^{2} {Q}_{T x} {Q}_{R x - L} {R}_{T x} \qquad ( 9 )$$

where Q_{Rx-L} was defined as:

$${Q}_{R x - L} = \frac{{Q}_{R x} {Q}_{L}}{{Q}_{R x} + {Q}_{L}} = \frac{ω {L}_{R x}}{{R}_{R x} + Re \{ {Z}_{l o a d} \}} \qquad ( 10 )$$

Considering the reflected impedance and assuming a series resonant Rx-circuit, the resulting Tx-inductor efficiency can be rewritten from (6) and (9) as:

$${η}_{{L}_{Tx}} = \frac{{R}_{Rx - {Tx}_{ref}}}{{R}_{Rx - {Tx}_{ref}} + {R}_{Tx}} = \frac{{k}_{Tx - Rx}^{2} {Q}_{Tx} {Q}_{Rx - L}}{{k}_{Tx - Rx}^{2} {Q}_{Tx} {Q}_{Rx - L} + 1} \qquad ( 11 )$$

Finally, the total efficiency of the wireless power transfer link shown in FIG. 11 is:

$${η}_{Link} = \frac{{Q}_{Rx - L}}{{Q}_{L}} \frac{{k}_{Tx - Rx}^{2} {Q}_{Tx} {Q}_{Rx - L}}{{k}_{Tx - Rx}^{2} {Q}_{Tx} {Q}_{Rx - L} + 1} \qquad ( 12 )$$

From (12) one can immediately observe that the link efficiency increases whenever, the coupling factor between and the quality factor of the associated inductors increases.

Additionally, the disclosed inductors and manufacturing method have the advantage that render substantially flat inductors that could function as the inductive element in the transmitter and receiver resonators that form the wireless power transfer system shown in FIG. 11, rendering the possibility of embedding these inductors into substantially flat devices like a mobile phone or a wearable electronic device.

In some implementations, the proposed manufacturing method avoids utilization of external components and having an increased overall thickness due to the additional substrate or conductive material used.

In some implementations, the proposed manufacturing method and inductor configurations allow to place additional circuitry on the substrate portion found inside the inductor 200.

The wireless power transmission system shown in FIG. 11 may comprise at least one inductor arrangement 200 as described above, in particular with respect to FIG. 1. The wireless power transmission system may comprise a transmitter resonator formed by the at least one inductor arrangement 200 as described above, in particular with respect to FIG. 1. The wireless power transmission system may comprise a relay resonator formed by the at least one inductor arrangement 200 as described above, in particular with respect to FIG. 1. The wireless power transmission system may comprise a receiver resonator formed by the at least one inductor arrangement 200 as described above, in particular with respect to FIG. 1. The wireless power transmission system may comprise a plurality of inductor arrangements 200 as described above, in particular with respect to FIG. 1, arranged in a three-dimensional array.

While a particular feature or aspect of the disclosure may have been disclosed with respect to only one of several implementations, such feature or aspect may be combined with one or more other features or aspects of the other implementations as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal. The terms “coupled” and “connected”, along with derivatives may have been used. It should be understood that these terms may have been used to indicate that two elements cooperate or interact with each other regardless whether they are in direct physical or electrical contact, or they are not in direct contact with each other.

Although specific aspects have been illustrated and described herein, it will be appreciated by those of ordinary skill in the art that a variety of alternate and/or equivalent implementations may be substituted for the specific aspects shown and described without departing from the scope of the disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

Many alternatives, modifications, and variations will be apparent to those skilled in the art in light of the above teachings. Of course, those skilled in the art readily recognize that there are numerous applications of the disclosure beyond those described herein. While the disclosure has been described with reference to one or more particular embodiments, those skilled in the art recognize that many changes may be made thereto without departing from the scope of the disclosure. It is therefore to be understood that within the scope of the appended claims and their equivalents, the disclosure may be practiced otherwise than as specifically described herein.

1. An inductor arrangement comprising:
a flat coil-shaped multi-layer substrate forming a planar inductor, wherein the flat coil-shaped multi-layer substrate comprises:
an insulating layer comprising a first side, a second side, a third side, and a fourth side;
a first conductive layer disposed on the first side;
a second conductive layer disposed on the second side; and
a third conductive layer disposed on the third side; and
a fourth conductive layer disposed on the fourth side, wherein the first conductive layer, the second conductive layer, the third conductive layer, and the fourth conductive layer are structured to form a tubular conductive layer, and wherein the tubular conductive layer encloses insulating layer; and
a printed circuit board, wherein the flat coil-shaped multi-layer substrate and the tubular conductive layer are arranged within the printed circuit board.

2. The inductor arrangement of claim 1, wherein the flat coil-shaped multi-layer substrate is arranged to form at least one turn of the planar inductor.

3. The inductor arrangement of claim 1, wherein the inductor arrangement is configured to generate or receive an electromagnetic field, and wherein the flat coil-shaped multi-layer substrate extends perpendicular to a principal direction of the electromagnetic field.

4. The inductor arrangement of claim 1, wherein the printed circuit board comprises:
an upper main face;
a lower main face opposing the upper main face;
two lateral faces between the lower main face and the upper main face;
the first conductive layer arranged at the upper main face; and
the second conductive layer arranged at the lower main face,
wherein the third conductive layer and the fourth conductive layer are arranged at the two lateral faces, and
wherein the third conductive layer and the fourth conductive layer are configured to electrically connect the first conductive layer with the second conductive layer.

5. The inductor arrangement of claim 4, wherein the first conductive layer is comprises a first thickness different from a second thickness of at least one of the second conductive layer, the third conductive layer, or the fourth conductive layer, or wherein the first conductive layer comprises a first material different from a second material of at least one of the second conductive layer, the third conductive layer, or the fourth conductive layer.

6. The inductor arrangement of claim 1, wherein the coil-shaped flat multi-layer substrate further comprises one or more bridges of non-conductive material, and wherein the one or more bridges partially interrupt the tubular conductive layer.

7. The inductor arrangement of claim 6, further comprising electrically conductive traces, wherein the one or more bridges provide a path for the electrically conductive traces to pass through the first conductive layer or the second conductive layer.

8. The inductor arrangement of claim 1, wherein the flat coil-shaped multi-layer substrate is arranged to form at least two turns of the planar inductor, and wherein the at least two turns are spaced apart from each other.

9. The inductor arrangement of claim 8, wherein the at least two turns are arranged on a same conductive layer of the flat coil-shaped multi-layer substrate, wherein a first turn of the at least two turns is arranged inside a second turn of the at least two turns, or wherein the first turn is arranged next to the second turn.

10. The inductor arrangement of claim 9, wherein the first turn comprises a first end section arranged inside the second turn, wherein the first end section forms a first terminal of the planar inductor for electrical connection of the planar inductor, wherein the second turn comprises a second end section, arranged outside the first turn, and wherein the second end section forms a second terminal of the planar inductor for an electrical connection of the planar inductor.

11. The inductor arrangement of claim 10, further comprising a second substrate comprising a first conductive track with a first contact pad and a second contact pad, wherein the second substrate is arranged above or below the flat coil-shaped multi-layer substrate, wherein the first contact pad contacts the first terminal to provide an electrical connection from inside the planar inductor to outside the planar inductor.

12. The inductor arrangement of claim 11, wherein the second substrate further comprises:
electrical circuitry; and
a second conductive track comprising a third contact pad and a fourth contact pad, wherein the third contact pad contacts the second terminal, wherein the first conductive track and the second conductive track provide an electrical connection of the planar inductor to the electrical circuitry.

13. The inductor arrangement of claim 10, further comprising a second substrate formed from an extension of the flat coil-shaped multi-layer substrate, wherein the second substrate comprises electrical circuitry and is arranged outside of the planar inductor, and wherein the coil-shaped flat multi-layer substrate comprises a conductive trace configured to electrically connect the first terminal the electrical circuitry.

14. The inductor arrangement of claim 13, wherein the coil-shaped flat multi-layer substrate comprises one or more bridges of non-conductive material formed to provide a path for the conductive trace.

15. A wireless power transmission system, comprising:
at least one inductor arrangement, wherein the at least one inductor arrangement comprises:
a flat coil-shaped multi-layer substrate forming a planar inductor, wherein the flat coil-shaped multi-layer substrate comprises:
an insulating layer comprising a first side, a second side, a third side, and a fourth side;
a first conductive layer disposed on the first side;
a second conductive layer disposed on the second side; and
a third conductive layer disposed on the third side; and
a fourth conductive layer disposed on the fourth side,
wherein the first conductive layer, the second conductive layer, the third conductive layer, and the fourth conductive layer are structured to form a tubular conductive layer, and wherein the tubular conductive layer encloses the insulating layer; and
a printed circuit board, wherein the flat coil-shaped multi-layer substrate and the tubular conductive layer are arranged within the printed circuit board.

16. The wireless power transmission system of claim 15, wherein the at least one inductor arrangement is configured to form one of a transmitter resonator, a relay resonator, or a receiver resonator.

17. The wireless power transmission system of claim 15, wherein the at least one inductor arrangement comprises a plurality of inductor arrangements, and wherein the inductor arrangements are arranged in a three-dimensional array.

18. A method comprising:
providing a multi-layer substrate comprising a first conductive layer, a second conductive layer, and an insulating layer so that the insulating layer separates the first conductive layer and the second conductive layer;
structuring the first conductive layer and the second conductive layer to form structured conductive layers, wherein the structured conductive layers are a planar inductor;
removing substrate material from edges of the structured conductive layers to provide a flat coil-shaped multi-layer substrate; and
depositing a third conductive layer and a fourth conductive layer on the insulating layer at the edges of the structured conductive layers so that the third conductive layer and fourth conductive layer electrically connect the structured conductive layers to form a tubular conductive layer enclosing the flat coil-shaped multi-layer substrate.

19. The method of claim 18, wherein structuring the first conductive layer and the second conductive layer and removing the substrate material are performed in a single processing step.

20. The method of claim 18, further comprising:
further structuring the first conductive layer and the second conductive layer to form at least two turns of the planar inductor; and
further removing the substrate material outside, inside, and in between the at least two turns.
